(19) United States
(12) Patent Application Publication
(10) Pub. No.: US 2019/0073302 A1
(43) Pub. Date: Mar. 7, 2019

(54) SSD BOOT BASED ON PRIORITIZED ENDURANCE GROUPS

(71) Applicant: Intel Corporation, Santa Clara, CA (US)

(72) Inventors: Michael S. Allison, Longmont, CO (US); Jonathan Hughes, Longmont, CO (US)

(73) Assignee: Intel Corporation, Santa Clara, CA (US)

(21) Appl. No.: 16/181,980

(22) Filed: Nov. 6, 2018

(51) Int. Cl. G06F 12/084; G06F 9/4401

(52) U.S. Cl. CPC G06F 12/084; G06F 9/4401

(57) ABSTRACT

An embodiment of a semiconductor apparatus may include technology to create two or more logical to physical translation maps for a persistent storage media, associate a respective group with each of the two or more logical to physical translation maps, assign priority information to the respective groups, and initialize the respective groups at boot time based on the assigned priority information. Another embodiment may further include technology to mark an initialized group as ready for commands. Other embodiments are disclosed and claimed.

### TECHNICAL FIELD

Embodiments generally relate to storage systems. More particularly, embodiments relate to solid state drive (SSD) boot based on prioritized endurance groups.

### BACKGROUND

A persistent storage device, such as a SSD, may include media such as NAND memory. Some SSDs may have limited endurance. For example, NAND memory may only be written a finite number of times, and the SSD may wear out as the SSD ages. The Non-Volatile Memory EXPRESS (NVMe) 1.3 specification (nvmexpress.org) may define and/or support various technologies to address various endurance issues.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an electronic storage system according to an embodiment;

FIG. 2 is a block diagram of an example of a semiconductor apparatus according to an embodiment;

FIGS. 3A to 3C are flowcharts of an example of a method of controlling storage according to an embodiment;

FIG. 4 is a block diagram of an example of an electronic processing system according to an embodiment;

FIG. 5 is a sequence diagram of an example of a process flow for controlling storage according to an embodiment;

FIG. 6 is a flowchart of another example of a method of controlling storage according to an embodiment;

FIG. 7 is a block diagram of an example of a computing system according to an embodiment; and

FIG. 8 is a block diagram of an example of a SSD according to an embodiment.

### DESCRIPTION OF EMBODIMENTS

Various embodiments described herein may include a memory component and/or an interface to a memory component. Such memory components may include volatile and/or nonvolatile memory (NVM). Volatile memory may be a storage medium that requires power to maintain the state of data stored by the medium. Non-limiting examples of volatile memory may include various types of random access memory (RAM), such as dynamic RAM (DRAM) or static RAM (SRAM). One particular type of DRAM that may be used in a memory module is synchronous dynamic RAM (SDRAM). In particular embodiments, DRAM of a memory component may comply with a standard promulgated by Joint Electron Device Engineering Council (JEDEC), such as JESD79F for double data rate (DDR) SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at www.jedec.org). Such standards (and similar standards) may be referred to as DDR-based standards and communication interfaces of the storage devices that implement such standards may be referred to as DDR-based interfaces.

NVM may be a storage medium that does not require power to maintain the state of data stored by the medium. In one embodiment, the memory device may include a block addressable memory device, such as those based on NAND or NOR technologies. A memory device may also include future generation nonvolatile devices, such as a three dimensional (3D) crosspoint memory device, or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor RAM (FeTRAM), anti-ferroelectric memory, magnetoresistive RAM (MRAM) memory that incorporates memristor technology, resistive memory including the metal oxide base, the oxygen vacancy base and the conductive bridge RAM (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory. The memory device may refer to the die itself and/or to a packaged memory product. In particular embodiments, a memory component with non-volatile memory may comply with one or more standards promulgated by the JEDEC, such as JESD218, JESD219, JESD220-1, JESD223B, JESD223-1, or other suitable standard (the JEDEC standards cited herein are available at jedec.org).

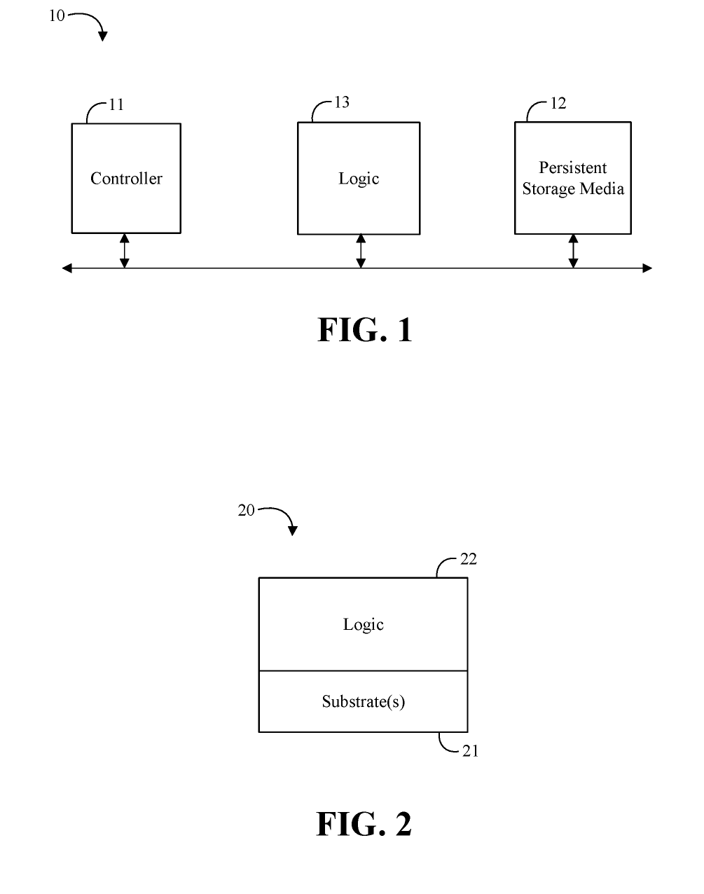

Turning now to FIG. 1, an embodiment of an electronic storage system 10 may include a controller 11, persistent storage media 12 communicatively coupled to the controller 11, and logic 13 communicatively coupled to the controller 11 and the persistent storage media 12 to create two or more logical to physical translation maps for the persistent storage media 12, associate a respective group with each of the two or more logical to physical translation maps, assign priority information to the respective groups, and initialize the respective groups at boot time based on the assigned priority information. In some embodiments, the logic 13 may be configured to load a logical to physical translation map associated with the group to be initialized, and replay any journals associated with the loaded logical to physical translation map. For example, the logic 13 may also be configured to mark the initialized group as ready for commands. In some embodiments, the logic 13 may be further configured to initialize two or more of the respective groups in parallel, and/or receive the priority information for the respective groups from a host. When two or more groups exist, for example, the same priority may be assigned to multiple groups. When initializing the groups in priority order, those groups with the same priority may be initialized in parallel, in some embodiments. For example, the persistent storage media 12 may include a SSD. In some embodiments, the logic 13 may be located in, or co-located with, various components, including the controller 11 (e.g., on a same die).

Embodiments of each of the above controller 11, persistent storage media 12, logic 13, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof. Embodiments of the controller 11 may include a general purpose controller, a microcontroller, a special purpose controller, a memory controller, a storage controller, a general purpose processor, a special purpose processor, a central processor unit (CPU), etc.

Alternatively, or additionally, all or portions of these components may be implemented in one or more modules as a set of logic instructions stored in a machine-readable or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, the persistent storage media 12 or other system memory may store a set of instructions which when executed by the controller 11 cause the system 10 to implement one or more components, features, or aspects of the system 10 (e.g., the logic 13, creating two or more logical to physical translation maps, associating a respective group with each of the two or more logical to physical translation maps, assigning priority information to the respective groups, initializing the respective groups at boot time based on the assigned priority information, etc.).

Turning now to FIG. 2, an embodiment of a semiconductor apparatus 20 may include one or more substrates 21, and logic 22 coupled to the one or more substrates 21, wherein the logic 22 is at least partly implemented in one or more of configurable logic and fixed-functionality hardware logic. The logic 22 coupled to the one or more substrates 21 may be configured to create two or more logical to physical translation maps for the persistent storage media, associate a respective group with each of the two or more logical to physical translation maps, assign priority information to the respective groups, and initialize the respective groups at boot time based on the assigned priority information. In some embodiments, the logic 22 may be configured to load a logical to physical translation map associated with the group to be initialized, and replay any journals associated with the loaded logical to physical translation map. For example, the logic 22 may also be configured to mark the initialized group as ready for commands. In some embodiments, the logic 22 may be further configured to initialize two or more of the respective groups in parallel, and/or receive the priority information for the respective groups from a host. When two or more groups exist, for example, the same priority may be assigned to multiple groups. When initializing the groups in priority order, those groups with the same priority may be initialized in parallel, in some embodiments. For example, the persistent storage media may include a SSD. In some embodiments, the logic 22 coupled to the one or more substrates 21 may include transistor channel regions that are positioned within the one or more substrates 21.

Embodiments of logic 22, and other components of the apparatus 20, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine-readable or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

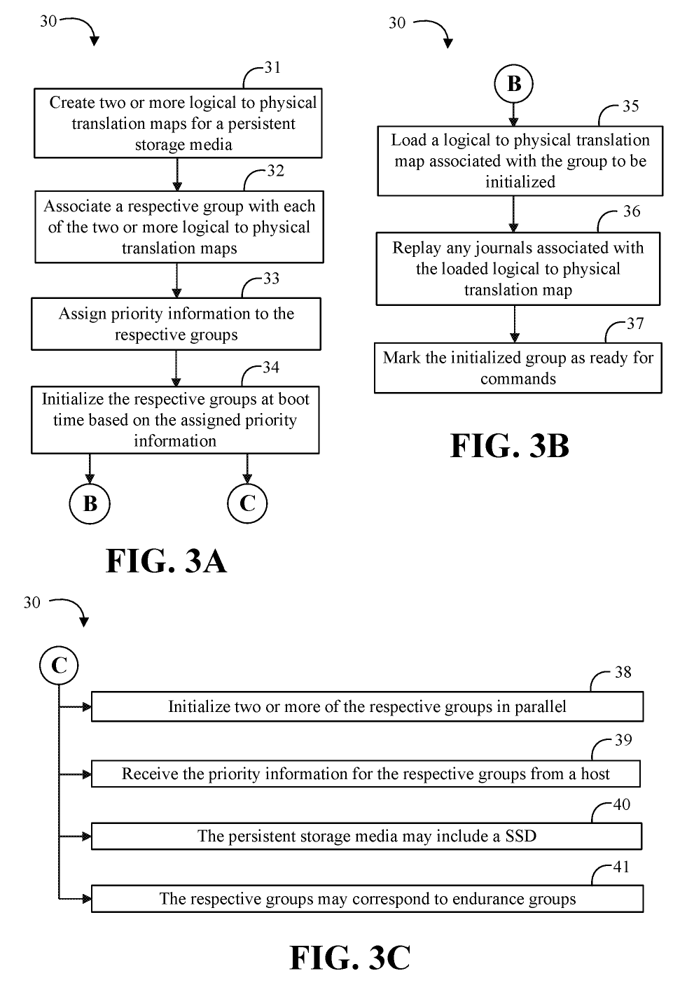

The apparatus 20 may implement one or more aspects of the method 30 (FIGS. 3A to 3C), or any of the embodiments discussed herein. In some embodiments, the illustrated apparatus 20 may include the one or more substrates 21 (e.g., silicon, sapphire, gallium arsenide) and the logic 22 (e.g., transistor array and other integrated circuit/IC components) coupled to the substrate(s) 21. The logic 22 may be implemented at least partly in configurable logic or fixed-functionality logic hardware. In one example, the logic 22 may include transistor channel regions that are positioned (e.g., embedded) within the substrate(s) 21. Thus, the interface between the logic 22 and the substrate(s) 21 may not be an abrupt junction. The logic 22 may also be considered to include an epitaxial layer that is grown on an initial wafer of the substrate(s) 21.

Turning now to FIGS. 3A to 3C, an embodiment of a method 30 of controlling storage may include creating two or more logical to physical translation maps for a persistent storage media at block 31, associating a respective group with each of the two or more logical to physical translation maps at block 32, assigning priority information to the respective groups at block 33, and initializing the respective groups at boot time based on the assigned priority information at block 34. Some embodiments of the method 30 may include loading a logical to physical translation map associated with the group to be initialized at block 35, and replaying any journals associated with the loaded logical to physical translation map at block 36. For example, the method 30 may also include marking the initialized group as ready for commands at block 37. Some embodiments of the method 30 may further include initializing two or more of the respective groups in parallel at block 38, and/or receiving the priority information for the respective groups from a host at block 39. When two or more groups exist, for example, the method 30 may include assigning the same priority may to multiple groups and, when initializing the groups in priority order, the method 30 may include initializing those groups with the same priority in parallel. For example, the persistent storage media may include a SSD at block 40, and/or the respective groups may correspond to endurance groups at block 41.

Embodiments of the method 30 may be implemented in a system, apparatus, computer, device, etc., for example, such as those described herein. More particularly, hardware implementations of the method 30 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 30 may be implemented in one or more modules as a set of logic instructions stored in a machine-readable or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the method 30 may be implemented on a computer readable medium as described in connection with Examples 21 to 27 below. Embodiments or portions of the method 30 may be implemented in firmware, applications (e.g., through an application programming interface (API)), or driver software running on an operating system (OS). Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Some embodiments may advantageously provide prioritization of endurance groups during SSD boot. Some other systems may require the entire SSD to boot before making a namespace accessible. Some embodiments may advantageously allow a host device to indicate the ordering of SSDs to load two or more different logical to physical translations tables (e.g., organized in groups), such that the host device may perform media operations to a namespace earlier during a boot sequence. For example, some embodiments may utilize NVMe supported endurance groups to create associated isolated logical to physical translation maps. The entries in the maps do not translate to the same physical memory location. The host may use the endurance groups to indicate prioritization for booting so the host can get namespace data from non-volatile storage to a portion of the SSD earlier during the host boot sequence. Some embodiments may provide technology to allow the host to isolate namespace user data required during the host's boot sequence to selected endurance group(s). The host may then specify to the SSD a prioritization to initialize the selected endurance group(s) containing the needed namespace over other endurance groups to provide earlier optimized access, advantageously decreasing the host's boot up timing.

Without being limited to specific implementations, NMVe-compliant SSDs may include a mapping table that translates a logical block address (LBA) to the physical address of the non-volatile storage that contains the data for that LBA. This mapping table, sometimes referred to as a logical-to-physical (L2P) table, may include an entry for each LBA. The L2P table may have a significant number of entries due to the storage sizes of some SSDs (e.g., multiple terabytes). Each write of an LBA causes data to be written to non-volatile storage and causes an update to L2P table.

In some systems, management of the L2P table may include having periodic snap shots of the table written to non-volatile storage along with storing periodic journals that indicate the changes to the L2P table since the last snapshot was stored. The journals may guarantee write ordering rules so the last association of an LBA to the physical address in a non-volatile storage component may be maintained. On power up of the SSD, the snapshots are loaded into the L2P table from non-volatile storage. Then the journals are read from non-volatile storage and the contents are used to update the changes that occurred to the L2P table. This update process may be referred to as a “replay” of the journal. The replay of all journals may be performed before the last known state of all LBAs is guaranteed.

The NVMe base specification (e.g., version 1.3) may define namespaces that contains LBAs. The storage of one namespace's LBAs may be interleaved with other namespaces' LBAs when stored on non-volatile storage components to take advantage of the write characteristics of the non-volatile devices, such as NAND media, and to minimize the internal buffering required to write namespaces separately. However, the interleaving of the LBAs for all namespaces may cause an issue during boot up to prepare namespaces that are required by the computer system early in its boot up sequence because all the journal data must be replayed to guarantee that the L2P table is coherent for any namespace.

A technical proposal (TP) 4018 may define NVM Sets and Read Recovery Level (Nov. 13, 2017) features. Such NVM Sets may allow non-volatile storage to be separated physically into groups referred to as “Endurance Groups.” For example, instead of a single large L2P table for the entire SSD, the L2P table may be grouped into two or more individual L2P tables with a respective L2P table for each Endurance Group. Each separate L2P table may have its own snapshot and set of journals. On a power up of the SSD, for each Endurance group, the snapshots may be loaded into the separate L2P tables from non-volatile storage. Then the journals may be read from non-volatile storage and replayed to update the separate L2P tables. Some embodiments may advantageously provide additional technology for the host device/system to identify a prioritization of Endurance Groups in relation to booting the host such that the attached SSD may prioritize the order to initialize these separate L2P tables. Some embodiments may advantageously assist in speeding up the host boot up sequence.

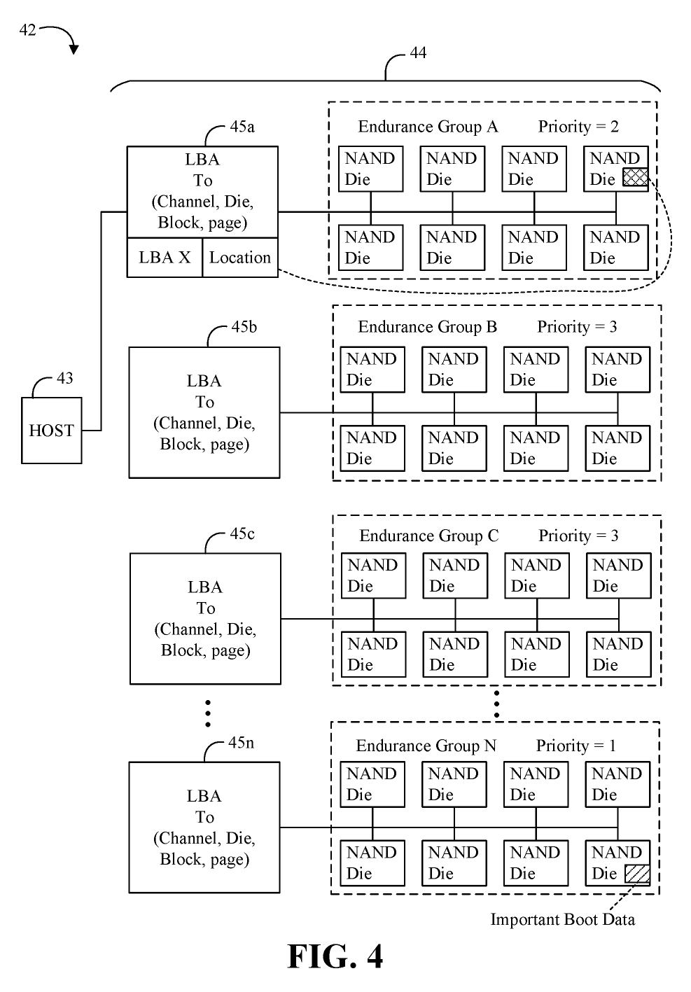

Turning now to FIG. 4, an electronic processing system 42 may include a host 43 communicatively coupled to a storage system 44. The storage system 44 may include two or more L2P tables 45a through 45n associated with respective groups A through N. For example, group A may correspond to Endurance Group A, group B may correspond to Endurance Group B, and so on. Each Endurance Group may include a set of media, such as the illustrated NAND die. The L2P tables may map between LBAs and physical locations in the media (e.g., based on channel, die, block, page, etc.). The system 42 may include logic (e.g., not shown, but distributed between the host 43 and the storage system 44) which provides a protocol between the host 43 and the storage system 44 to allow the host 43 to set the prioritization of the groups/Endurance Groups. On each boot up of the storage system 44, for example, the Endurance Group(s) with relatively higher priority may be given priority of internal resources of the storage system 44 (e.g., over Endurance Group(s) with relatively lower priority) to load the snap shot of the associated L2P table(s) and replay the corresponding journal(s). A suitably configured storage system 44 may initialize the L2P tables from multiple Endurance Groups with different priorities provided there are sufficient internal resources. The system 42 may further include logic to report from the storage system 44 to the host 43 when each Endurance Group has booted up and is ready for commands (e.g., to mark each Endurance Group individually with a ready status when that Endurance Group is ready).

Some other systems may utilize a single L2P table for the entire storage system such that important boot data cannot be made available to the host 43 until after the entire L2P table is loaded and all journals have been replayed. Some other systems may also provide just a single overall ready status for all of the Endurance Groups. Advantageously, some embodiments may provide multiple L2P tables 45a-n for the persistent storage media, associate a different Endurance Group A-N with each of the L2P tables, assign priority information to the Endurance Groups, and initialize the Endurance Groups at boot time based on the assigned priority information.

As illustrated in FIG. 4, for example, important boot data may be located in Endurance Group N. The host 43 may communicate the priority information to the storage system 44 such that a highest priority (e.g., Priority=1) is assigned to Endurance Group N. Endurance Group A may include data which is not as high priority as the important boot data but which is higher priority than other data, such that an intermediate priority is assigned to Endurance Group A (e.g., Priority=2). The remaining Endurance Groups may be assigned the lowest priority (e.g., Priority=3). Those skilled in the art will appreciate that numerous other techniques may be utilized for providing priority information that distinguishes relatively higher priority Endurance Groups from relatively lower priority Endurance Groups.

During boot, the storage system 44 may determine that Endurance Group N has the highest priority, load the L2P table 45n associated with Endurance Group N first (e.g., before other Endurance Groups with lower priority), and then replay the journal(s) corresponding to the L2P table 45n. The storage system 44 may then mark the Endurance Group N with a ready status, and report that information to the host 43. The host 43 may then access the Endurance Group N and utilize the important boot data as needed to continue the boot process of the host 43.

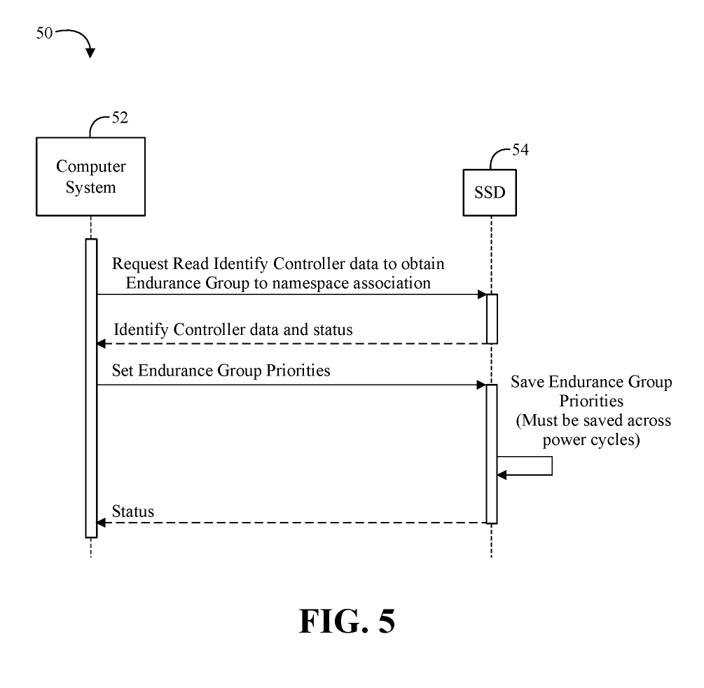

Turning now to FIG. 5, an embodiment of a process flow 50 for controlling storage may include actions performed by a computer system 52 and a SSD 54. For example, the illustrated sequence diagram may correspond to a protocol used for the computer system 52 to get the association of Endurance Groups, NVM Sets, namespaces, etc. from the SSD 54. After receiving suitable information from the SSD 54, the computer system 52 may set the priorities of the Endurance Groups based on the priority of namespaces needed during the booting of the computer system 52. The SSD 54 may store the priority information received from the computer system 52 in NVM to save the information across power cycles. At boot time, the SSD 54 may then initialize the Endurance Groups based on the saved priority information (e.g., initializing relatively higher priority Endurance Groups before initializing relatively lower priority Endurance Groups). After each Endurance Group is initialized, the SSD 54 may report the status to the computer system 52. Advantageously, the computer system 52 may resume activities (e.g., boot) after a needed Endurance Group is reported as ready without having to wait for the entire SSD 54 to initialize all of the Endurance Groups.

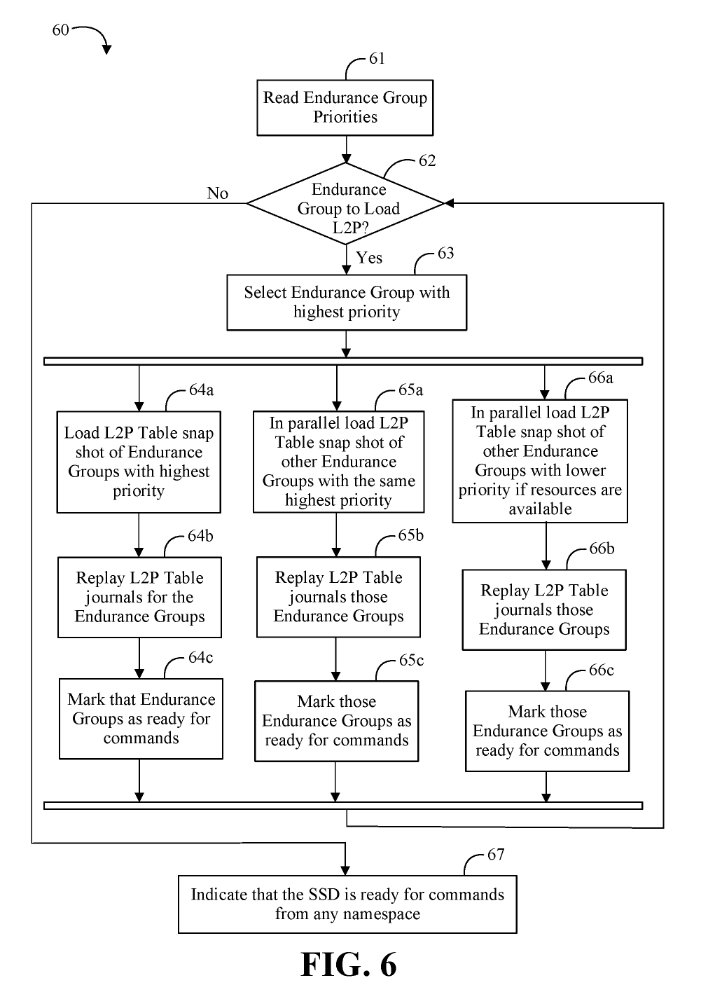

Turning now to FIG. 6, an embodiment of a method 60 of controlling storage may show SSD boot activity in relation to initializing the L2P tables for the Endurance Groups based on priority (e.g., priority information previously received from a host device). The method 60 may include reading the Endurance Group priorities at block 61 and determining if all Endurance Groups have been initialized at block 62. If not, the L2P tables for the Endurance Groups with the highest priority are selected at block 63, and initialized first at blocks 64a to 64c. For example, initializing the Endurance Groups may include loading the L2P table snapshot at block 64a, replaying the L2P table journal(s) at block 64b, and marking the Endurance Group as ready for commands at block 64c. The number of L2P tables that can be initialized in parallel is proportional to the resources available in the SSD which is not shown. If there are resources available to load L2P tables from the lower priority Endurance Groups, then that can be accommodated. For example, the method 60 may include initializing additional Endurance Groups with the same priority in parallel if there are sufficient resources at blocks 65a to 65c. The method 60 may further include initializing additional Endurance Groups with lower priority in parallel if there are sufficient resources at blocks 66a to 66c. When all Endurance Groups have been initialized at block 62, the method 60 may include indicating that the SSD is ready for commands from any namespace at block 67.

The technology discussed herein may be provided in various computing systems (e.g., including a non-mobile computing device such as a desktop, workstation, server, rack system, etc., a mobile computing device such as a smartphone, tablet, Ultra-Mobile Personal Computer (UMPC), laptop computer, ULTRABOOK computing device, smart watch, smart glasses, smart bracelet, etc., and/or a client/edge device such as an Internet-of-Things (IoT) device (e.g., a sensor, a camera, etc.)).

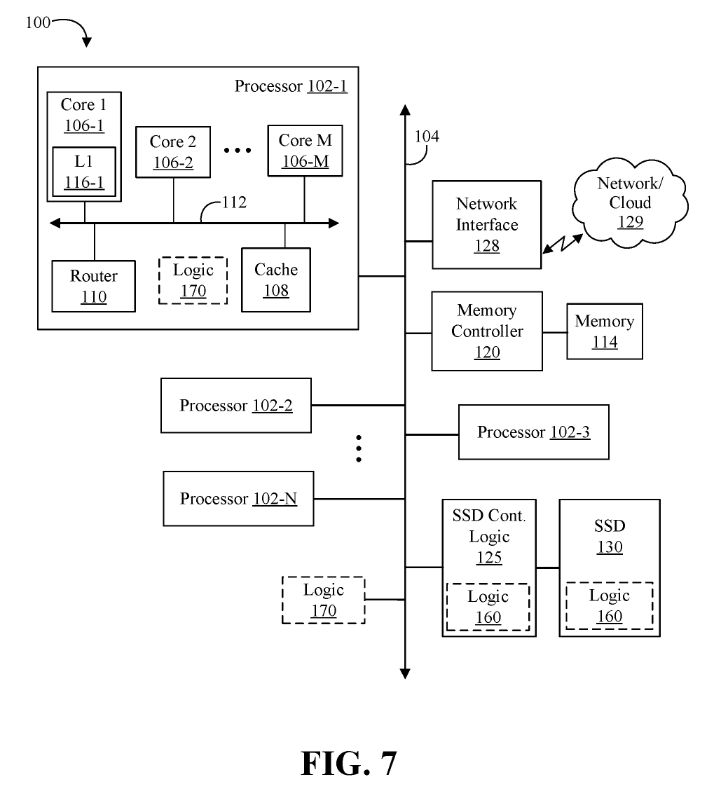

Turning now to FIG. 7, an embodiment of a computing system 100 may include one or more processors 102-1 through 102-N (generally referred to herein as “processors 102” or “processor 102”). The processors 102 may communicate via an interconnection or bus 104. Each processor 102 may include various components some of which are only discussed with reference to processor 102-1 for clarity. Accordingly, each of the remaining processors 102-2 through 102-N may include the same or similar components discussed with reference to the processor 102-1.

In some embodiments, the processor 102-1 may include one or more processor cores 106-1 through 106-M (referred to herein as “cores 106,” or more generally as “core 106”), a cache 108 (which may be a shared cache or a private cache in various embodiments), and/or a router 110. The processor cores 106 may be implemented on a single integrated circuit (IC) chip. Moreover, the chip may include one or more shared and/or private caches (such as cache 108), buses or interconnections (such as a bus or interconnection 112), logic 160, memory controllers, or other components.

In some embodiments, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The cache 108 may store data (e.g., including instructions) that is utilized by one or more components of the processor 102-1, such as the cores 106. For example, the cache 108 may locally cache data stored in a memory 114 for faster access by the components of the processor 102. As shown in FIG. 7, the memory 114 may be in communication with the processors 102 via the interconnection 104. In some embodiments, the cache 108 (that may be shared) may have various levels, for example, the cache 108 may be a mid-level cache and/or a last-level cache (LLC). Also, each of the cores 106 may include a level 1 (L1) cache (116-1) (generally referred to herein as “L1 cache 116”). Various components of the processor 102-1 may communicate with the cache 108 directly, through a bus (e.g., the bus 112), and/or a memory controller or hub.

As shown in FIG. 7, memory 114 may be coupled to other components of system 100 through a memory controller 120. Memory 114 may include volatile memory and/or NVM (e.g., INTEL OPTANE technology) and may be interchangeably referred to as main memory. Even though the memory controller 120 is shown to be coupled between the interconnection 104 and the memory 114, the memory controller 120 may be located elsewhere in system 100. For example, memory controller 120 or portions of it may be provided within one of the processors 102 in some embodiments.

The system 100 may communicate with other devices/systems/networks via a network interface 128 (e.g., which is in communication with a computer network and/or the cloud 129 via a wired or wireless interface). For example, the network interface 128 may include an antenna (not shown) to wirelessly (e.g., via an Institute of Electrical and Electronics Engineers (IEEE) 802.11 interface (including IEEE 802.11a/b/g/n/ac, etc.), cellular interface, 3G, 4G, LTE, BLUETOOTH, etc.) communicate with the network/cloud 129.

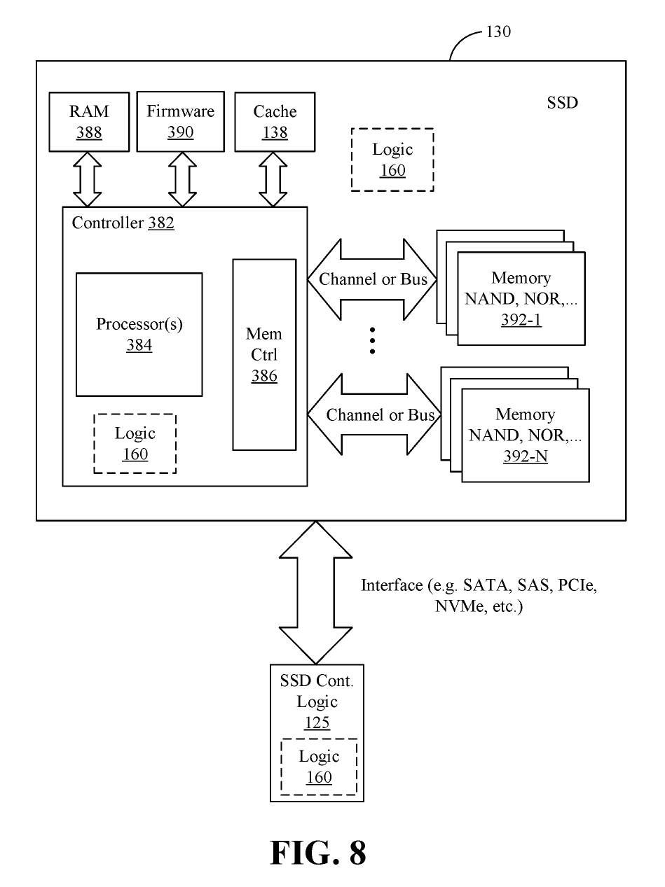

System 100 may also include Non-Volatile (NV) storage device such as a SSD 130 coupled to the interconnect 104 via SSD controller logic 125. Hence, logic 125 may control access by various components of system 100 to the SSD 130. Furthermore, even though logic 125 is shown to be directly coupled to the interconnection 104 in FIG. 7, logic 125 can alternatively communicate via a storage bus/interconnect (such as the SATA (Serial Advanced Technology Attachment) bus, Peripheral Component Interconnect (PCI) (or PCI EXPRESS (PCIe) interface), NVM EXPRESS (NVMe), etc.) with one or more other components of system 100 (for example where the storage bus is coupled to interconnect 104 via some other logic like a bus bridge, chipset, etc. Additionally, logic 125 may be incorporated into memory controller logic (such as those discussed with reference to FIG. 8) or provided on a same integrated circuit (IC) device in various embodiments (e.g., on the same IC device as the SSD 130 or in the same enclosure as the SSD 130).

Furthermore, logic 125 and/or SSD 130 may be coupled to one or more sensors (not shown) to receive information (e.g., in the form of one or more bits or signals) to indicate the status of or values detected by the one or more sensors. These sensor(s) may be provided proximate to components of system 100 (or other computing systems discussed herein), including the cores 106, interconnections 104 or 112, components outside of the processor 102, SSD 130, SSD bus, SATA bus, logic 125, logic 160, etc., to sense variations in various factors affecting power/thermal behavior of the system/platform, such as temperature, operating frequency, operating voltage, power consumption, and/or inter-core communication activity, etc.

As illustrated in FIG. 7, SSD 130 may include logic 160, which may be in the same enclosure as the SSD 130 and/or fully integrated on a printed circuit board (PCB) of the SSD 130. The system 100 may include further logic 170 outside of the SSD 130. Advantageously, the logic 160 and/or logic 170 may include technology to implement one or more aspects of the method 30 (FIGS. 3A to 3C), the process flow 50 (FIG. 5), and/or the method 60 (FIG. 6). For example, the logic 160 may include technology to create two or more logical to physical translation maps for the SSD 130, associate a respective group with each of the two or more logical to physical translation maps, assign priority information to the respective groups, and initialize the respective groups at boot time based on the assigned priority information. In some embodiments, the logic 160 may be configured to load a logical to physical translation map associated with the group to be initialized, and replay any journals associated with the loaded logical to physical translation map. For example, the logic 160 may also be configured to mark the initialized group as ready for commands. In some embodiments, the logic 160 may be further configured to initialize two or more of the respective groups in parallel, and/or receive the priority information for the respective groups from one of the processors 102. For example, the logic 170 may include technology to implement the host device/computer system aspects of the various embodiments described herein (e.g., requesting information from the SSD 130, communicating priority information to the SSD 130, etc.).

In other embodiments, the SSD 130 may be replaced with any suitable persistent storage technology/media that utilizes translation maps. For example, some embodiments may utilize a hard disk drive (HDD) where there may not be a direct relationship of LBAs to a specific location on a platter/track/etc. In some embodiments, the logic 160 may be coupled to one or more substrates (e.g., silicon, sapphire, gallium arsenide, printed circuit board (PCB), etc.), and may include transistor channel regions that are positioned within the one or more substrates. As shown in FIG. 7, features or aspects of the logic 160 and/or the logic 170 may be distributed throughout the system 100, and/or co-located/integrated with various components of the system 100.

FIG. 8 illustrates a block diagram of various components of the SSD 130, according to an embodiment. As illustrated in FIG. 8, logic 160 may be located in various locations such as inside the SSD 130 or controller 382, etc., and may include similar technology as discussed in connection with FIG. 7. SSD 130 includes a controller 382 (which in turn includes one or more processor cores or processors 384 and memory controller logic 386), cache 138, RAM 388, firmware storage 390, and one or more memory modules or dies 392-1 to 392-N (which may include NAND flash, NOR flash, or other types of non-volatile memory). Memory modules 392-1 to 392-N are coupled to the memory controller logic 386 via one or more memory channels or busses. Also, SSD 130 communicates with logic 125 via an interface (such as a SATA, SAS, PCIe, NVMe, etc., interface). One or more of the features/aspects/operations discussed with reference to FIGS. 1-7 may be performed by one or more of the components of FIG. 8. Processors 384 and/or controller 382 may compress/decompress (or otherwise cause compression/decompression) of data written to or read from memory modules 392-1 to 392-N. Also, one or more of the features/aspects/operations of FIGS. 1-7 may be programmed into the firmware 390. Further, SSD controller logic 125 may also include logic 160.

### ADDITIONAL NOTES AND EXAMPLES

Example 1 includes a semiconductor apparatus for use with persistent storage media, comprising one or more substrates, and logic coupled to the one or more substrates, wherein the logic is at least partly implemented in one or more of configurable logic and fixed-functionality hardware logic, the logic coupled to the one or more substrates to create two or more logical to physical translation maps for the persistent storage media, associate a respective group with each of the two or more logical to physical translation maps, assign priority information to the respective groups, and initialize the respective groups at boot time based on the assigned priority information.

Example 2 includes the apparatus of Example 1, wherein the logic is further to load a logical to physical translation map associated with the group to be initialized, and replay any journals associated with the loaded logical to physical translation map.

Example 3 includes the apparatus of Example 2, wherein the logic is further to mark the initialized group as ready for commands.

Example 4 includes the apparatus of any of Examples 1 to 3, wherein the logic is further to initialize two or more of the respective groups in parallel.

Example 5 includes the apparatus of any of Examples 1 to 4, wherein the logic is further to receive the priority information for the respective groups from a host.

Example 6 includes the apparatus of any of Examples 1 to 5, wherein the persistent storage media comprises a solid state drive.

Example 7 includes the apparatus of any of Examples 1 to 6, wherein the logic coupled to the one or more substrates includes transistor channel regions that are positioned within the one or more substrates.

Example 8 includes an electronic storage system, comprising a controller, persistent storage media communicatively coupled to the controller, and logic communicatively coupled to the controller and the persistent storage media to create two or more logical to physical translation maps for the persistent storage media, associate a respective group with each of the two or more logical to physical translation maps, assign priority information to the respective groups, and initialize the respective groups at boot time based on the assigned priority information.

Example 9 includes the system of Example 8, wherein the logic is further to load a logical to physical translation map associated with the group to be initialized, and replay any journals associated with the loaded logical to physical translation map.

Example 10 includes the system of Example 9, wherein the logic is further to mark the initialized group as ready for commands.

Example 11 includes the system of any of Examples 8 to 10, wherein the logic is further to initialize two or more of the respective groups in parallel.

Example 12 includes the system of any of Examples 8 to 11, wherein the logic is further to receive the priority information for the respective groups from a host.

Example 13 includes the system of any of Examples 8 to 12, wherein the persistent storage media comprises a solid state drive.

Example 14 includes a method of controlling storage, comprising creating two or more logical to physical translation maps for a persistent storage media, associating a respective group with each of the two or more logical to physical translation maps, assigning priority information to the respective groups, and initializing the respective groups at boot time based on the assigned priority information.

Example 15 includes the method of Example 14, further comprising loading a logical to physical translation map associated with the group to be initialized, and replaying any journals associated with the loaded logical to physical translation map.

Example 16 includes the method of Example 15, further comprising marking the initialized group as ready for commands.

Example 17 includes the method of any of Examples 14 to 16, further comprising initializing two or more of the respective groups in parallel.

Example 18 includes the method of any of Examples 14 to 17, further comprising receiving the priority information for the respective groups from a host.

Example 19 includes the method of any of Examples 14 to 18, wherein the persistent storage media comprises a solid state drive.

Example 20 includes the method of any of Examples 14 to 19, wherein the respective groups correspond to endurance groups.

Example 21 includes at least one computer readable storage medium, comprising a set of instructions, which when executed by a computing device, cause the computing device to create two or more logical to physical translation maps for a persistent storage media, associate a respective group with each of the two or more logical to physical translation maps, assign priority information to the respective groups, and initialize the respective groups at boot time based on the assigned priority information.

Example 22 includes the at least one computer readable storage medium of Example 21, comprising a further set of instructions, which when executed by the computing device, cause the computing device to load a logical to physical translation map associated with the group to be initialized, and replay any journals associated with the loaded logical to physical translation map.

Example 23 includes the at least one computer readable storage medium of Example 22, comprising a further set of instructions, which when executed by the computing device, cause the computing device to mark the initialized group as ready for commands.

Example 24 includes the at least one computer readable storage medium of any of Examples 21 to 23, comprising a further set of instructions, which when executed by the computing device, cause the computing device to initialize two or more of the respective groups in parallel.

Example 25 includes the at least one computer readable storage medium of any of Examples 21 to 24, comprising a further set of instructions, which when executed by the computing device, cause the computing device to receive the priority information for the respective groups from a host.

Example 26 includes the at least one computer readable storage medium of any of Examples 21 to 25, wherein the persistent storage media comprises a solid state drive.

Example 27 includes the at least one computer readable storage medium of any of Examples 21 to 26, wherein the respective groups correspond to endurance groups.

Example 28 includes a storage controller apparatus, comprising means for creating two or more logical to physical translation maps for a persistent storage media, means for associating a respective group with each of the two or more logical to physical translation maps, means for assigning priority information to the respective groups, and means for initializing the respective groups at boot time based on the assigned priority information.

Example 29 includes the apparatus of Example 28, further comprising means for loading a logical to physical translation map associated with the group to be initialized, and means for replaying any journals associated with the loaded logical to physical translation map.

Example 30 includes the apparatus of Example 29, further comprising means for marking the initialized group as ready for commands.

Example 31 includes the apparatus of any of Examples 28 to 30, further comprising means for initializing two or more of the respective groups in parallel.

Example 32 includes the apparatus of any of Examples 28 to 31, further comprising means for receiving the priority information for the respective groups from a host.

Example 33 includes the apparatus of any of Examples 28 to 32, wherein the persistent storage media comprises a solid state drive.

Example 34 includes the apparatus of any of Examples 28 to 33, wherein the respective groups correspond to endurance groups.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A semiconductor apparatus for use with persistent storage media, comprising:
one or more substrates; and
logic coupled to the one or more substrates, wherein the logic is at least partly implemented in one or more of configurable logic and fixed-functionality hardware logic, the logic coupled to the one or more substrates to:
create two or more logical to physical translation maps for the persistent storage media,
associate a respective group with each of the two or more logical to physical translation maps,
assign priority information to the respective groups, and
initialize the respective groups at boot time based on the assigned priority information.

2. The apparatus of claim 1, wherein the logic is further to:
load a logical to physical translation map associated with the group to be initialized; and
replay any journals associated with the loaded logical to physical translation map.

3. The apparatus of claim 2, wherein the logic is further to:
mark the initialized group as ready for commands.

4. The apparatus of claim 1, wherein the logic is further to:
initialize two or more of the respective groups in parallel.

5. The apparatus of claim 1, wherein the logic is further to:
receive the priority information for the respective groups from a host.

6. The apparatus of claim 1, wherein the persistent storage media comprises a solid state drive.

7. The apparatus of claim 1, wherein the logic coupled to the one or more substrates includes transistor channel regions that are positioned within the one or more substrates.

8. An electronic storage system, comprising:
a controller;
persistent storage media communicatively coupled to the controller; and
logic communicatively coupled to the controller and the persistent storage media to:
create two or more logical to physical translation maps for the persistent storage media,
associate a respective group with each of the two or more logical to physical translation maps,
assign priority information to the respective groups, and
initialize the respective groups at boot time based on the assigned priority information.

9. The system of claim 8, wherein the logic is further to:
load a logical to physical translation map associated with the group to be initialized; and
replay any journals associated with the loaded logical to physical translation map.

10. The system of claim 9, wherein the logic is further to:
mark the initialized group as ready for commands.

11. The system of claim 8, wherein the logic is further to:
initialize two or more of the respective groups in parallel.

12. The system of claim 8, wherein the logic is further to:
receive the priority information for the respective groups from a host.

13. The system of claim 8, wherein the persistent storage media comprises a solid state drive.

14. A method of controlling storage, comprising:
creating two or more logical to physical translation maps for a persistent storage media;
associating a respective group with each of the two or more logical to physical translation maps;
assigning priority information to the respective groups; and
initializing the respective groups at boot time based on the assigned priority information.

15. The method of claim 14, further comprising:
loading a logical to physical translation map associated with the group to be initialized; and
replaying any journals associated with the loaded logical to physical translation map.

16. The method of claim 15, further comprising:
marking the initialized group as ready for commands.

17. The method of claim 14, further comprising:
initializing two or more of the respective groups in parallel.

18. The method of claim 14, further comprising:
receiving the priority information for the respective groups from a host.

19. The method of claim 14, wherein the persistent storage media comprises a solid state drive.

20. The method of claim 14, wherein the respective groups correspond to endurance groups.
